(19) United States
(12) Patent Application Publication
(10) Pub. No.: US 2026/0130494 A1
(43) Pub. Date: May 14, 2026

(54) BRUSH-HEAD FOR POWERED TOOTHBRUSH DEVICES

(71) Applicants: Lei Wang, Irvine, CA (US); Ziqing Wang, Irvine, CA (US)

(72) Inventors: Lei Wang, Irvine, CA (US); Ziqing Wang, Irvine, CA (US)

(21) Appl. No.: 18/940,858

(22) Filed: Nov. 8, 2024

(51) Int. Cl. A46B 9/04; A61C 17/22

(52) U.S. Cl. CPC A46B 9/045; A61C 17/22; A46B 2200/1066

(57) ABSTRACT

This disclosure provides a brush-head for use with powered toothbrush devices. The bristles of the brush-head are arranged to form a groove that allows bristle shafts to contact the surfaces of at least one tooth for cleaning actions in addition to bristle tips. The groove also embraces a top edge of the tooth to guide proper placement of the brush-head on the tooth. The brush-head adapts to the shape of teeth to clean hard-to-reach areas and guides its traveling along the tooth row, providing enhanced cleaning and easy use.

### BACKGROUND OF THE INVENTION

Powered toothbrushes have been a valuable device for oral care. For example, a vibrating toothbrush, such as a sonic energy driving toothbrush, cleans teeth by scrubbing surfaces with the tips of bristles and by utilizing the hydrodynamic effect created by the bristle-fluid interactions. While the rapid, automatic bristle motions generated by powered toothbrushes bring benefits for cleaning teeth, the arrangement of bristles on brush-heads remains a key factor affecting overall toothbrush efficacy. A common feature of brush-head designs focuses on arranging bristle tips to form a geometrical contact surface for brushing. Tooth surfaces, such as those in interproximal, gingival and posterior areas, may not be well covered as movements of bristle tips are restrained by the contact surface or at least by a portion of the contact surface. Despite designs with multileveled bristle tufts, individually flexible tufts and multi-headed have demonstrated improvement of cleaning efficacy, achieving effective cleaning is still a key goal of the brush-head design.

While brushing, the bristle-tip formed contact surface is generally pushed against the surfaces of teeth to achieve cleaning efficacy. The level of pressure for effective cleaning and for positioning the brush-head is often suggested in tooth brushing methods provided by dentists and user manuals. However, optimized pressure is hard to achieve. As a result, some areas may not be well cleaned and some tissues can even be damaged during brushing. Hence, the benefits of powered toothbrushes may not be fully realized.

### SUMMARY OF THE INVENTION

The present invention provides a brush-head that allows bristle shafts to contact the surfaces of teeth for cleaning actions in addition to bristle tips. The brush-head can also guide itself into proper positions while being used. The brush-head disclosed and described herein is preferably used with any powered toothbrush device that provides movements comprising at least one of vibration, spinning, and sonic oscillation.

According to one aspect of the present invention, the brush-head comprises a base plate and a plurality of rows of bristles extending from a surface of the base plate. The bristles are generally perpendicular to the surface. The rows of bristles comprise two outer rows of bristles and at least one central row of bristles between the two outer rows of bristles, each of the rows of bristles being further arranged into a plurality of bristle tufts. The bristles in the central row are relatively shorter, and the bristles in the two outer rows are longer than each bristle in the central row so that a groove is formed to have a space between the two outer rows. The width of the groove is between 2.5 millimeters and 8 millimeters, and the length of the bristles in the central row is less than the length of each bristle in the two outer rows by at least 2.5 millimeters. The arrangement of the groove allows the brush-head to embrace a top edge of at least one tooth when the brush-head is placed on the tooth at an angle, so that the shafts and tips of bristles in the two outer rows can contact the surfaces of the tooth. With the angle varying, the shafts and tips of the bristles in the two outer rows contact other parts of the surfaces and gingiva areas, and the brush-head remains rest on teeth while traveling along the dental arch in which the tooth is in.

According to another aspect of the present invention, the brush-head comprises a base plate and two rows of bristles extending from a surface of the base plate. The bristles are generally perpendicular to the surface. The rows of bristles are arranged into a plurality of bristle tufts, and the two rows are spaced from each other to form a groove between the two rows, wherein the width of the groove is between 2.5 millimeters and 8 millimeters, whereby the groove embraces a top edge of the tooth when the brush-head is placed on the tooth at an angle, the shafts and tips of the bristles in the two rows contact the surfaces of the tooth, with the angle varying, the shafts and tips of the bristles contact other parts of the surfaces and gingiva areas, and the brush-head remains rest on teeth while traveling along the dental arch in which the tooth is in.

### BRIEF DESCRIPTION OF DRAWINGS

FIG. 1 shows a brush-head example according to an aspect of the present invention and the brush-head in use for cleaning a tooth, wherein FIG. 1a shows a top view of the brush-head, FIG. 1b shows an end view of the brush-head, FIG. 1c and FIG. 1d show the brush-head resting on a tooth at different angles, respectively.

FIG. 2 shows a brush-head example according to another aspect of the present invention and the brush-head in use for cleaning a tooth, wherein FIG. 2a shows a top view of the brush-head, FIG. 2b shows an end view of the brush-head, FIG. 2c and FIG. 2d show the brush-head resting on a tooth at different angles, respectively.

FIG. 3 shows a further brush-head example according to an aspect of the present invention, wherein FIG. 3a shows a top view of the brush-head and FIG. 3b shows an end view of the brush-head.

FIG. 4 shows a further brush-head example according to another aspect of the present invention, wherein FIG. 4a shows a top view of the brush-head and FIG. 4b shows an end view of the brush-head.

FIG. 5 shows an embodiment of the brush-head in accordance with an aspect of the present invention, wherein FIG. 5a shows a top view of the brush-head and FIG. 5b shows an end view of the brush-head.

FIG. 6 shows an embodiment of the brush-head according to another aspect of the present invention, wherein FIG. 6a shows a top view of the brush-head and FIG. 6b shows an end view of the brush-head.

FIG. 7 show a brush-head example in use for cleaning top surfaces of teeth.

FIG. 8 show a brush-head example in use for cleaning side surfaces of teeth.

### DETAILED DESCRIPTION OF THE INVENTION

The present invention will be described with reference to drawings and the same reference numerals are used throughout the drawings to indicate the same or similar parts, or geometrical shapes.

It should be understood that the following descriptions and preferred embodiments, which are merely exemplary, are not intended to limit the scope of the present invention. The description of illustrative embodiments according to the aspects of the present invention is intended to be read in connection with the accompanying drawings and appended claims. It should be understood that the drawings are merely schematic and are not drawn to scale, and features of one embodiment may be incorporated with other embodiments as skilled persons would recognize.

In the following descriptions, it must be noted that as used herein and in the appended claims, the phrase ‘a top edge’ refers to one of the edges including the buccal-occlusal edge of a tooth, the occlusal-lingual edge of a tooth, the top edge on the buccal side of a tooth, the top edge on the lingual side of a tooth. It must be also noted that the brush-head disclosed and described herein is preferably used with a powered toothbrush device that provides movements comprising at least one of vibration, spinning, and sonic oscillation.

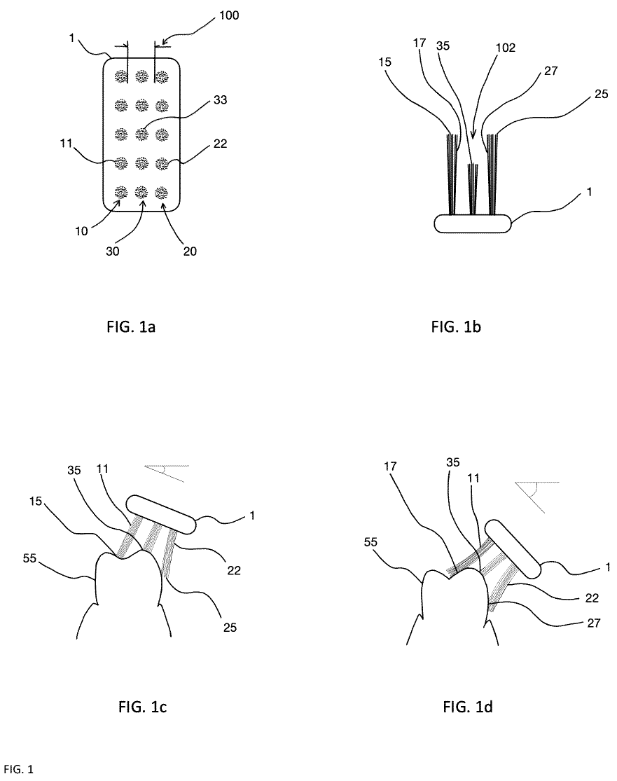

One embodiment of the brush-head is illustrated in FIG. 1. FIG. 1a and FIG. 1b show the views of the brush-head from the top and from an end, respectively. In the preferred embodiment, the brush-head comprises a base plate 1, typically having a longitudinal axis. The base plate 1 could have a square or round shape that has identical in-plane axes and in this case, an axis is arbitrarily chosen as the longitudinal axis. The brush-head further comprises a plurality of rows of bristles extending from a surface of the base plate 1. The bristles are generally perpendicular to the surface. The plurality of rows comprises two outer rows and at least of one central row between the two outer rows. In FIG. 1, two outer rows 10, 20, and one central row 30 are illustrated. Bristles in each row are further arranged into a plurality of bristle tufts, five such tufts being shown in each row, respectively bristle tufts 11, 22, and 33. The rows of bristles are generally parallel to the longitudinal axis. The bristles in the central row 30 are relatively shorter than each of the bristles in the two outer rows 10 and 20 such that the bristle tips 15, 25, and the bristle shafts 17, 27 of the outer rows and the bristle tips 35 of the central row 30 define a groove 102. The width 100 of the groove 102 is between 2.5 millimeters and 8 millimeters, preferably around 5 millimeters, and the bristles in the central row are at least 2.5 millimeters shorter than each bristle in the two outer rows, preferably around 4.5 millimeters. Such an arrangement allows the groove to receive a top edge of at least one tooth so that the bristle shafts 17, 27 can contact the surfaces of the tooth and the brush-head can rest on the tooth. In addition to cleaning actions, the central row 30 can support the brush-head to stay on the tooth while being in use.

FIG. 1c and FIG. 1d show end views of the brush-head being placed on a tooth at two different angles, respectively. In FIG. 1c, the brush-head is placed at smaller angle with respect to a plane generally parallel to the top surface of the tooth 55. The groove 102 receives a top edge of the tooth 55 with the bristle tips 15 contacting the top of the tooth 55, the bristle tips 35 contacting the edge area of the tooth 55, and the bristle tips 25 contacting the side surface of the tooth 55. The bristle tips 15, 25, 35 can scrub against the surfaces of the tooth 55 when the brush-head is activated by a powered toothbrush device. The bristle tips 35 may support the brush-head to rest on the tooth 55. When the brush-head is rolled at a greater angle, as shown in FIG. 1d, the bristle tufts 11 slightly flexes and keeps the brush-head rest on the tooth 55, with the bristle shafts 17 contacting the top surface of the tooth 55, the bristle tips 35 contacting the edge area of the tooth 55, the bristle tufts 22 being flexed and the bristle shafts 27 contacting the side surface of the tooth 55.

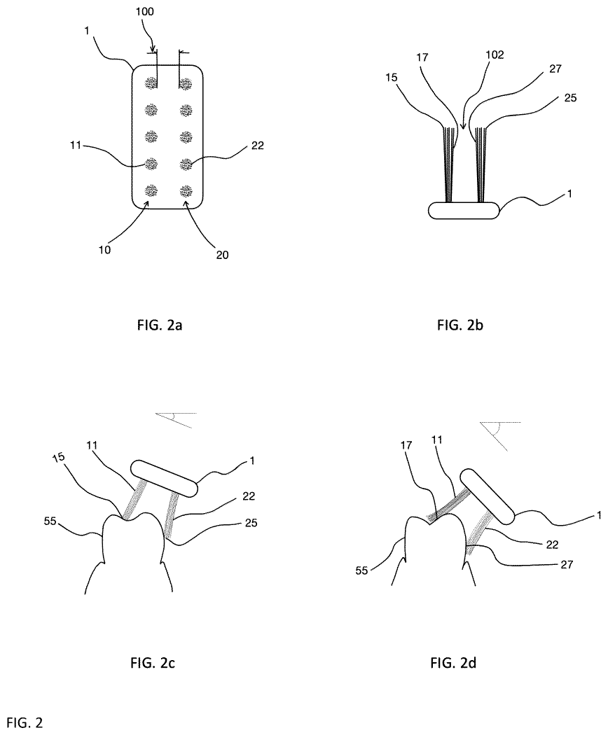

FIG. 2 shows another embodiment of the brush-head according to one or more aspects of the present invention. As shown in FIG. 2a and FIG. 2b, the brush-head comprises a base plate 1 having a longitudinal axis and two rows 10, 20 of bristles extending from a surface of the base plate 1. The bristles are generally perpendicular to the surface. The base plate 1 typically has a longitudinal axis. The base plate 1 could have a square or round shape that has identical in-plane axes and in this case, an axis is arbitrarily chosen as the longitudinal axis. The bristles in the rows 10, 20 are arranged into a plurality of bristle tufts 11 and 22, respectively. The two rows 10, 20 are spaced from each other to form a groove between the rows. The width 100 of the groove is between 2 millimeters and 8 millimeters, preferably around 5 millimeters. The arrangement allows the groove 102 to receive a top edge of at least one tooth so that the bristle shafts 17, 27 can contact the surfaces of the tooth and the brush-head can rest on the tooth.

FIG. 2c and FIG. 2d show end views of the brush-head being placed on a tooth at two different angles, respectively. In FIG. 2c, the brush-head is placed on the tooth 55 at smaller angle with respect to a plane generally parallel to the top surface of the tooth 55. The groove 102 receives a top edge of the tooth 55 with the bristle tips 15 contacting the top of the tooth 55, and the bristle tips 25 contacting the side surface of the tooth 55. The bristle tips 15, 25 scrub against the surfaces of the tooth 55 when the brush-head is activated by a powered toothbrush device. When the brush-head is rolled at a greater angle, as shown in FIG. 2d, the bristle tufts 11 slightly flexes and keeps the brush-head rest on the tooth 55, with the bristle shafts 17 contacting the top surface of the tooth 55, the bristle tufts 22 being flexed and the bristle shafts 27 contacting the side surface of the tooth 55.

The rows of bristles 10, 20 shown in FIG. 1 and FIG. 2 are formed as bristle tufts 11 and 22 and are further arranged in even spaced row patterns parallel to the longitudinal axis of the base plate 1. The bristles tufts 11 and 22 on the brush-head may be arranged in various row-like patterns and take various shapes, such as in different size, elongated in one dimension.

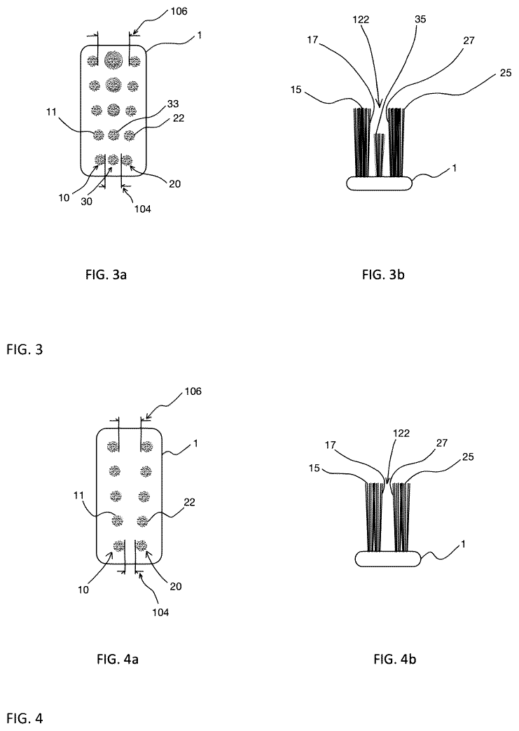

In some preferred embodiments in accordance with one or more aspects of the present invention, the brush-head is configured such that the rows of bristles 10, 20 diverge from each other from one end of the base plate 1 to define the groove, preferably from the proximal end from which a neck extends. FIG. 3a and FIG. 3b show a top view and an end view of the brush-head, respectively. FIG. 3a and FIG. 3b illustrate such the groove 122 defined by the bristle tips 15, 25, and the bristle shafts 17, 27, of the rows 10, 20, and the bristle tips 35 of the central row 30. The groove 122 has a gradually increasing width along the longitudinal axis of the plate 1, with the minimum width 104 at one end, preferably at the proximal end, and with the maximum width 106 at the other end. The size of bristle tufts 33 in the central row may also vary to match the shape of the groove 122. In FIG. 4a and FIG. 4b, the groove 122 is formed by the rows 10, 20 and has a gradually increasing width along the longitudinal axis of the plate 1, with the minimum width 104 at one end, preferably at the proximal end, and with the maximum width 106 at the other end. Such an arrangement of the rows of bristles 10, 20 can match the variations of the tooth size and the arrangement of the teeth on dental arches. In embodiments illustrated in FIG. 3 and FIG. 4, the minimum width 104 is preferably around 4 millimeters, and the maximum width 106 is preferably around 6 millimeters.

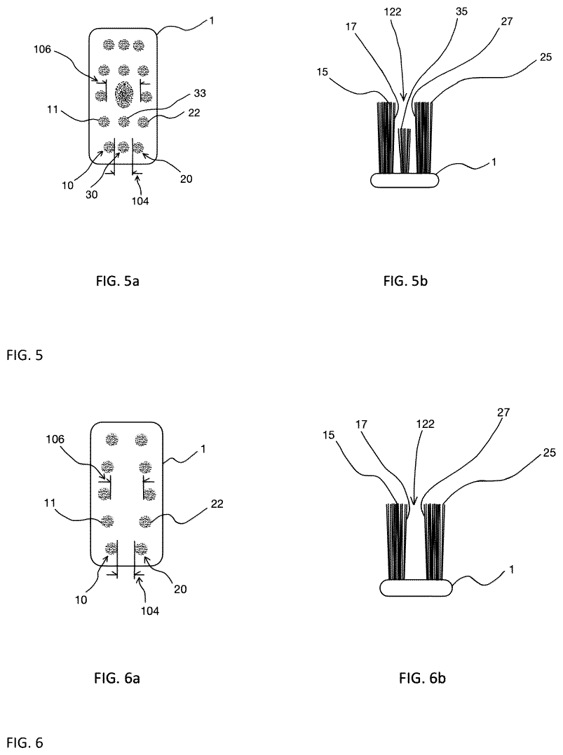

In other preferred embodiments in accordance with one or more aspects of the present invention, the footprints of the rows of bristles 10, 20 on the base plate 1 are in a general arcuate shape. FIG. 5a and FIG. 5b illustrate an example of the brush-head having the groove 122 formed by two outer rows of bristles 10, 20 and one central row of bristles 30. The bristle tufts 33 near the middle portion of the central row may be arranged in greater size or more than one tuft laterally to match the shape of the groove 122. In FIG. 5, an enlarged bristle tufts is arranged near the middle of the central row. The groove 122 has the maximum width 106 near the middle portion of the rows 10, 20, and has the minimum width 104 at the ends. FIG. 6a and FIG. 6b illustrate an embodiment of the brush-head in which the groove 122 formed by the rows of bristles 10, 20. The groove 122 has the maximum width 106 near the middle portion of the rows 10, 20, and has the minimum width 104 at the ends. The arrangement can improve cleaning of interproximal areas as the bristles are arranged to match the shape of the tooth. In embodiments illustrated in FIG. 5 and FIG. 6, the minimum width 104 is preferably around 4 millimeters, and the maximum width 106 is preferably around 6 millimeters.

As shown in FIG. 1 through FIG. 6, due to the presence of the groove 102 or 122, it is not necessary to press the brush-head firmly onto the tooth 55 in order to properly position the brush-head onto a top edge of the tooth 55 and to push the bristle shafts 17, 27 and tips 15, 25 towards the surfaces of the tooth because slight pressure or the weight of the brush-head can make the bristles flex from their sides. When bristle tufts 11 and 22 are flexed, the bristle tufts deform to let individual bristle reach smalls features on the surfaces of the tooth, such as pits and fissures on the occlusal surface of the tooth, and interdental areas. The deformed bristle tufts 11, 22 also adapt to the curvature of the tooth. When a powered toothbrush device drives the brush-head, the bristles rapidly scrub the surfaces with their shafts 17, 27 and tips 15, 25. Varying the angle at which the brush-head is rolled allows the bristle shafts 17, 27 and tips 15, 25 to reach various surfaces of the tooth 55 and the gingival area. It should be understood that depending on the angle at which the brush-head is rolled, a combination of the bristle tips 15, 25 and the bristle shafts 17, 27 of the rows of bristles 10, 20 may contact the surfaces of the tooth for cleaning actions. When the brush-head is placed on the buccal-occlusal edge of the tooth 55 for cleaning, the bristle shafts 17 and tips 15 contact the occlusal surfaces of the tooth 55, and the bristle shafts 27 and tips 25 contact the buccal surfaces and gingival area of the tooth 55. When the brush-head is slowly moved along the tooth row, the groove 102 or 122 keeps the brush-head rest on the tooth row and the bristles maintain adaptation to the tooth surfaces for cleaning actions with the bristle shafts 17, 27 and tips 15, 25. The brush-head is then placed on the occlusal-lingual edge of teeth for cleaning the lingual side. In this way, the proper cleaning of the interproximal areas is also achieved while the brush-head traveling between teeth for cleaning.

Although the grooves 122 in the embodiments illustrated in FIG. 3 through FIG. 6 have shapes different from the groove 102 in the embodiments shown in FIG. 1 through FIG. 2, it should be understood that their functions and advantages are essentially similar, and are in accordance with one or more aspects of the present invention.

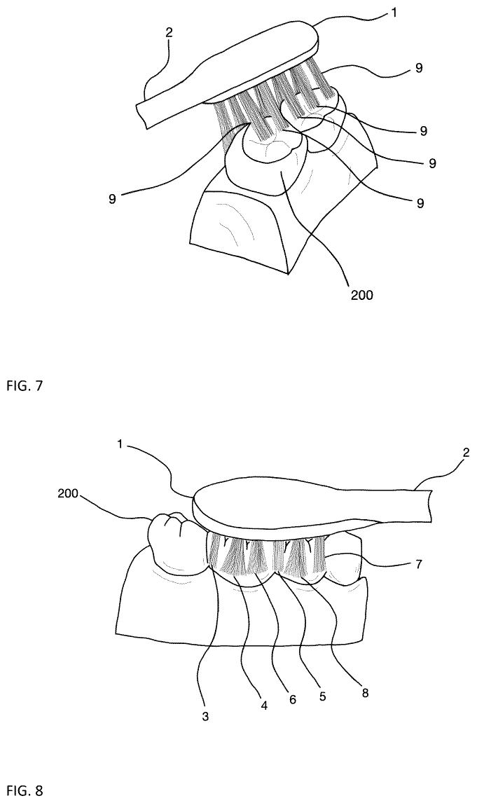

FIG. 7 and FIG. 8 show the perspective views of the brush-head in use according to one or more aspects of the present invention, respectively. FIG. 7 illustrates the brush-head configured with two rows of bristles being placed on a row of teeth 200. The brush-head has a base plate 1, and a neck 2 extending from the base plate 1. The brush-head has a groove formed by the two rows of bristles and embracing top edges of the teeth 200. One of the two rows of bristles formed by of five bristle tufts 9 contact the top surfaces of the teeth 200 with their bristle shafts and tips. The other row of bristles contacts the side surfaces of teeth 200, and only some bristles tufts in the other row are visible in FIG. 7.

FIG. 8 illustrates a perspective view of the brush-head being placed on a row of teeth 200 in accordance with one or more aspects of the present invention. The brush-head has a base plate 1, and a neck 2 extending from the base plate 1. Only one of the rows on the outer side is visible in FIG. 8. The visible row of bristles has bristle tufts 3, 4, 5, 6, 7, 8 that contact the side surfaces of the teeth 200. Bristle tufts 4, 6, 8 are deformed to fit the side surfaces of the teeth 200, and bristle tufts 3, 5, 7 are less deformed and reach the interproximal areas for cleaning. As illustrated in FIG. 7 and FIG. 8, the brush-head can conform the shape of teeth and cover hard-to-reach areas using the bristle shafts and hence can improve cleaning efficacy.

In preferred embodiments described in accordance with the present invention, the bristles in the rows 10, 20 have one of the shapes comprising round shape, conical, tapered, curved and spiral shape. For example, the bristles may be curved bristles, which are arranged curving inward toward the groove to cover more detailed surfaces of the tooth.

As illustrated in above preferred embodiments in accordance with one or more aspects of the present invention, the groove allows the brush-head to be easily positioned on the teeth to clean various surfaces and areas with its bristle shafts and tips. Bristles are generally more flexible along their sides and can precisely adapt to the surfaces of the tooth to scrub hard-to-reach areas such as small features on occlusal surfaces, interproximal areas. By contrast, the reach of bristle tips in conventional brush-heads is generally limited in the range determined by the geometrical surface formed by the bristle tips, or at least by a plurality of bristle tufts. The groove also makes the brush-head travel steadily between teeth. Only a slight pressure may be applied to clean teeth with consistency and ease because less effort is required to hold the brush-head against teeth. Additionally, as the groove embraces top edges of teeth, the brush-head is generally less elevated from tooth surfaces, thus it is more comfortable to use.

Although some preferred embodiments and advantages of the invention have been described herein for illustrations, it should be understood that a variety of bristle conformations and geometrical arrangement of the groove may be incorporated in embodiments without departing from the spirit of the present invention.

1. A brush-head for use with powered toothbrush devices, comprising:
a base plate,
a plurality of rows of bristles extending from a surface of the base plate, comprising two outer rows of bristles and at least one central row of bristles between the two outer rows of bristles, each of the rows of bristles being arranged into a plurality of bristle tufts, the bristles in the two outer rows of bristles being longer than each bristle in the central row of bristles so that a groove is formed to have a space between the two outer rows of bristles, wherein the width of the groove being between 2.5 millimeters and 8 millimeters and the length of the bristles in the central row of bristles being shorter than the length of each bristle in the two outer rows of bristles by at least 2.5 millimeters, whereby the groove embraces a top edge of at least one tooth when the brush-head is placed on the tooth at an angle, the shafts and tips of bristles in the two outer rows contact different surfaces of the tooth while the angle varying, and the brush-head can rest on a plurality of tooth while traveling along the dental arch in which the tooth is in.

2. A brush-head as claimed in claim 1, wherein each of the two outer rows of bristles is arranged to have an arcuate footprint on the base plate such that the groove has a maximum width near the middle of the two outer rows of bristles and has a minimum width at the ends of the two outer rows of bristles.

3. A brush-head as claimed in claim 2, wherein the maximum width is less than 8 millimeters and the minimum width is at least 2.5 millimeters.

4. A brush-head as claimed in claim 2, wherein the central row of bristles is arranged to have either more bristle tufts or a plurality of enlarged bristle tufts near the middle of the central row of the bristles such that the contour of the central row of bristles approximately matches the shape of the groove.

5. A brush-head as claimed in claim 1, wherein the two outer rows of bristles are arranged such that the groove has a minimum width at one end of the base plate, and gradually widens toward the other end of the base plate to have a maximum width.

6. A brush-head as claimed in claim 5, wherein the maximum width is less than 8 millimeters and the minimum width is at least 2.5 millimeters.

7. A brush-head as claimed in claim 5, wherein the central row of bristles is arranged to have gradually enlarged bristle tufts such that the contour of the central row of bristles approximately matches the shape of the groove.

8. A brush-head as claimed in claim 1, wherein the bristles have at least one shape selected from the set of conical, tapered, curved and spiral shapes.

9. A brush-head as claimed in claim 1, wherein the brush-head has two outer rows of bristles and one central row of bristles.

10. A brush-head for use with powered toothbrush devices, comprising:
a base plate,
two rows of bristles extending from a surface of the base plate, each of the rows of bristles being arranged into a plurality of bristle tufts, the two rows of bristles spaced from each other to form a groove between the two rows of bristles, wherein the width of the groove being between 2.5 millimeters and 8 millimeters, whereby the groove embraces a top edge of at least one tooth when the brush-head is placed on the tooth at an angle, the shafts and tips of the bristles in the two rows of bristles contact different surfaces of the tooth while the angle varying, and the brush-head can rest on a plurality of tooth while traveling along the dental arch in which the tooth is in.

11. A brush-head as claimed in claim 10, wherein each of the two rows of bristles is arranged to have an arcuate footprint on the base plate such that the groove has a maximum width near the middle of the two rows of bristles and has a minimum width at the ends of the two rows of bristles.

12. A brush-head as claimed in claim 11, wherein the maximum width is less than 8 millimeters and the minimum width is at least 2.5 millimeters.

13. A brush-head as claimed in claim 10, wherein the two rows of bristles are arranged such that the groove has a minimum width at one end of the base plate, and gradually widens toward the other end of the base plate to have a maximum width.

14. A brush-head as claimed in claim 13, the maximum width is less than 8 millimeters and the minimum width is at least 2.5 millimeters.

15. A brush-head as claimed in claim 10, wherein the bristles have at least one shape selected from the set of conical, tapered, curved and spiral shapes.
